(19) United States
(12) Patent Application Publication
(10) Pub. No.: US 2023/0403434 A1
(43) Pub. Date: Dec. 14, 2023

(54) STREAMING SERVICE RATING DETERMINATION

(71) Applicant: VEEGO SOFTWARE LTD., Ramat Gan (IL)

(72) Inventors: Ronen KONDRATOVSKY, Petah Tikva (IL); Sergey VOLKOVICH, Rehovot (IL); Reffael CASPI, Tel Aviv (IL)

(21) Appl. No.: 18/209,036

(22) Filed: Jun. 13, 2023

Related U.S. Application Data
(60) Provisional application No. 63/351,545, filed on Jun. 13, 2022.

(51) Int. Cl. H04N 21/475; H04N 21/44; H04N 21/466; H04N 21/845

(52) U.S. Cl. CPC H04N 21/4756; H04N 21/44004; H04N 21/4665; H04N 21/8456

(57) ABSTRACT

A computer-implemented method comprising: receiving, at a communications network interface, telemetry data representing a streaming service instance provided to an end-device by a remote streaming server over the Internet; and recursively, with respect to each current time window: (i) dividing, based on the telemetry data, the time window into segments, wherein each of the segments is classified based on its buffering status as a buffering segment or a non-buffering segment, (ii) calculating a current streaming service score, based on the buffering status of at least one of the segments within the current time window, and (iii) updating a quality of service (QoS) rating for the streaming media service instance, based, at least in part, on the current streaming service score.

### CROSS-REFERENCE TO RELATED APPLICATIONS

This application claims the benefit of priority from U.S. Provisional Patent Application No. 63/351,545, filed Jun. 13, 2022 entitled, “STREAMING SERVICE RATING DETERMINATION,” the contents of which are hereby incorporated by reference in their entirety.

### FIELD OF THE INVENTION

The invention relates to the field of data communication networks and machine learning.

### BACKGROUND

Maintaining an adequate level of service for online services and applications is essential for attracting and retaining customers for these services.

The inherent variability in the quality of service (QoS) achieved by various end devices drives many complaints to network Internet Service Providers (ISPs). In turn, the QoS of the final network segment has a significant effect on the quality of experience (QoE) of three customer operating the end device. For ISPs, the performance of home or residential networks is a particular problem, because it is largely beyond the control of, and invisible to, the ISPs, although it may be the ultimate cause of a large number of calls to ISP helplines.

Different web applications, such as streaming media, gaming, or audio/video live conferencing, have different traffic patterns and associated Quality of Service (QoS) requirements, such as in terms of bandwidth, latency, loss, delay, jitter (variation in delay), and best-effort options.

For instance, streaming media applications are particularly sensitive to the bandwidth of the internet connection, or the data rate over the connection as measured in bits per second. Streaming media applications are also sensitive to the rate of packet loss over the connection, which results in loss of data on the user side. Accordingly, to properly determine the QoS experienced by a streaming user, it is vital for content providers to monitor a set of QoS parameters such as bandwidth, packet loss, and others, that are essential to this type of service.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: receive, at a communications network interface, telemetry data representing a streaming service instance provided to an end-device by a remote streaming server over the Internet, and recursively, with respect to each current time window: (i) divide, based on the telemetry data, the time window into segments, wherein each of the segments is classified based on its buffering status as a buffering segment or a non-buffering segment, (ii) calculate a current streaming service score, based on the buffering status of at least one of the segments within the current time window, and (iii) update a quality of service (QoS) rating for the streaming media service instance, based, at least in part, on the current streaming service score.

There is also provided, in an embodiment, a computer-implemented method comprising: receiving, at a communications network interface, telemetry data representing a streaming service instance provided to an end-device by a remote streaming server over the Internet; and recursively, with respect to each current time window: (i) dividing, based on the telemetry data, the time window into segments, wherein each of the segments is classified based on its buffering status as a buffering segment or a non-buffering segment, (ii) calculating a current streaming service score, based on the buffering status of at least one of the segments within the current time window, and (iii) updating a quality of service (QoS) rating for the streaming media service instance, based, at least in part, on the current streaming service score.

There is further provided, in an embodiment, a computer program product comprising a non-transitory computer-readable storage medium having program instructions embodied therewith, the program instructions executable by at least one hardware processor to: receive, at a communications network interface, telemetry data representing a streaming service instance provided to an end-device by a remote streaming server over the Internet; and recursively, with respect to each current time window: (i) divide, based on the telemetry data, the time window into segments, wherein each of the segments is classified based on its buffering status as a buffering segment or a non-buffering segment, (ii) calculate a current streaming service score, based on the buffering status of at least one of the segments within the current time window, and (iii) update a quality of service (QoS) rating for the streaming media service instance, based, at least in part, on the current streaming service score.

In some embodiments, (i) the buffering segments include segments representing initial or ongoing buffering representing periods of filling or depleting of a buffer associated with the end-device, and (ii) the non-buffering segments include segments in which the buffering status cannot be determined or segments in which the data rate is below a specified threshold.

In some embodiments, the last one of the segments ending within the current time window is classified as a buffering segment, the current streaming service score is equal to a last segment score, calculated as a weighted combination of: (i) a data rate score based on a standard deviation of the data rate metrics in the last one of the segments; and (ii) a packet loss score based on the packet loss rate metrics in the last one of the segments.

In some embodiments, the current streaming service score is further based on a longest segment score, calculated based on the data rate metrics and a time duration value of the longest one of the segments classified as a buffering segment and ending within the current time window.

In some embodiments, the current streaming service score is equal to a current window buffering score calculated as a weighted combination of (i) the last segment score, and (ii) the longest segment score.

In some embodiments, the current streaming service score is further based on an historical buffering score, calculated based on time duration values of at least some of the segments classified as buffering segments in one or more time windows preceding the current time window.

In some embodiments, the historical buffering score is based on: (i) a mean duration score based on a mean time duration, and (ii) a standard deviation score based on a standard deviation, of the some of the segments classified as buffering segments in the one or more time windows preceding the current time window.

In some embodiments, the current streaming service score is calculated as a weighted combination of (i) the current window buffering score, and (ii) the historical buffering score.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1A illustrates an exemplary streaming network environment which may provide for real-time monitoring and evaluating of the overall quality of a streaming media service connection, in accordance with various aspects of the present disclosure;

FIG. 1B illustrates an exemplary playback buffering instance that can reduce interruptions in video playback due to fluctuations in the incoming network bitrates, in accordance with various aspects of the present disclosure;

FIG. 2 shows a block diagram of an exemplary system for real-time monitoring and evaluating of the overall quality of a streaming media service connection, in accordance with some embodiments of the present disclosure; and

FIG. 3 illustrates the functional steps in a method for real-time monitoring and evaluating of the overall quality of a streaming media service connection, in accordance with some embodiments of the present disclosure;

FIG. 4 shows an exemplary buffering-status segments repository, in accordance with some embodiments of the present disclosure; and

FIG. 5A shows an exemplary Current Time Window Buffering Score calculation, according to some embodiments of the present disclosure;

FIG. 5B shows an exemplary Historical Buffering Score calculation, according to some embodiments of the present disclosure; and

FIG. 5C shows an Overall Quality Score calculation, according to some embodiments of the present disclosure.

### DETAILED DESCRIPTION

Disclosed herein is a technique, embodied in a system, method and computer program product, for real-time monitoring and evaluating of the overall quality of a streaming media service connection. Embodiments described herein are directed to approaches for determining a quality of experience (QoE) of a user of an end-device or end-station within a communications network, which executes an online streaming media application. In some embodiments, the service connection may be a wired or wireless link between a streaming media source over a communication network delivery path to the end-station.

Streaming media is delivered over a communication network from a source to an end-user, typically with little or no intermediate storage along the network delivery path. Streaming video and audio are classified as continuous media, because they consist of a sequence of media quanta (such as audio samples or video frames), which convey meaningful information only when presented in time. Thus, streaming is an alternative to file downloading, where the end-user must obtain the entire digital file for the content before playback can begin. Through streaming, the end-user can start playing the media before the entire file has been transmitted. The term “streaming media” usually applies to video and audio; however, other types of media may be streamed using similar methods.

There are challenges with streaming content on the Internet. For example, users whose Internet connection lacks sufficient bandwidth may experience stops, lags, or poor buffering of the content. Despite network improvements, streaming media quality can still suffer during periods of congestion when networks do not have enough capacity to meet current demands. Congestion for streaming video means that the rate the video that is received by a client player is lower than the rate that the video requires to be played out. When this happens, the video must inevitably stop playing until enough data has arrived to resume playout. Even when the overall average receive rate is greater than the average playback rate, fluctuations in the rate over the life of the video playback can cause instances where the momentary receive rate is insufficient to meet playback demands.

Streaming experience for participants is thus dependent on the speed and quality of data transmission over their respective network connections. Data transmission includes a downstream data path and an upstream data path. Downstream paths normally refer to transmission from a web server to a workstation or personal computer user. Upstream data transmission is the opposite, with data originating in the workstation or personal computer and transmitted to the web server. In the example of a streaming service network, the information which passes in the downstream path between the streaming server and end-stations includes media content in the form of a digital file. Overall quality-of-service (QoS) to an end-user using a typical web connection is dependent mostly upon the downstream QoS. Thus, streaming networks rely on downstream feeds of video and audio files having a minimum required bandwidth for uninterrupted performance.

The three main issues affecting the performance of streaming media over internet connections may be defined as:
Bandwidth: The term ‘bandwidth’ has traditionally referred to a measure of capacity, i.e., the maximum amount of data that can be transmitted over a link or connection between two points in a communication network. However, maximum notional channel bandwidth does not necessarily indicate the actual effective throughput of the channel, which can be reduced by transmission protocol overhead, encryption, retransmissions, and other factors.
Some streaming systems are configured to select a streaming bitrate based on the streaming bandwidth conditions determined at the client device. For example, media content can be encoded at varying bitrates, each providing a different level of media resolution and associated quality. Thus, when bandwidth conditions are determined to be deteriorated, the streaming service may select to stream media encoded at a lower resolution, resulting in a decrease in the perceptual quality of the streamed media as perceived by the end-user.
Packet loss: Packet loss is the rate of dataframe loss, i.e., dataframes that should have been forwarded by a network but did not reach their destination. A number of different types of losses may occur, depending on the particular network under consideration. Losses can have a negative effect on the reconstructed video quality. Packet loss may be detected by comparing sequential numbers of downstream control packets sent to client and sequential numbers extracted from upstream packets received from client. The ratio of the number of lost packets to the number of downstream control packets defined a packet-loss ratio.
In this regards, the Internet Protocol (IP) is designed as a best-effort, rather than a guaranteed, delivery service. Therefore, packet loss over network paths should be taken into consideration when determining QoS. Generally, packet loss occurs when one or more packets of data travelling across a computer network fail to reach their destination. Packet loss is either caused by errors in data transmission, or network congestion. Thus, when reliable delivery is necessary, packet loss increases latency due to the additional time needed for retransmission, which negatively affects user QoE. To avoid some of these issues, the Internet Protocol allows for routers to drop packets if the router or a network segment is too busy to deliver the data in a timely fashion. The dropping of packets by network nodes provides an indication to senders that the network is congested.
Latency jitter: Jitter is the variation in the amount of time that it takes a data packet to make a roundtrip from the streaming media service to the client and back. Latency jitter is measured in the variability over time of the end-to-end delay across the network path. The end-to-end delay that a packet experiences may fluctuate from packet to packet. This variation is a problem because the receiver must receive/decode/display frames at a constant rate, and any late frames resulting from the delay jitter can produce problems in the reconstructed video, e.g. more jerky and less smooth video.

Streaming protocols typically use buffering of the content for a specified period of time (usually a few seconds) in advance of playback, to overcome network connection limitations and ensure streaming continuity. A playback buffer is used at the client side in order to compensate for variations in received throughput, due to the dynamic nature of the connection conditions, as well as variations in video encoding rate. The choice of playback buffer size presents a trade-off between minimizing the time delay before a video starts, and minimizing interrupts during playing.

In a non-limiting example, the present disclosure may operate within the context of a local area network (LAN) comprising one or more end streaming devices, e.g., end stations (STAs). A LAN may be connected to the Internet through an access point (AP) and/or a gateway, such as a broadband modem and/or router. In a typical LAN environment, a user may access the Internet by connecting a client device (which may be a wireless device) to a server on the Internet, via intermediate devices and networks. In some implementations, a client device may be connected to a LAN configured to communicate with servers on a wide area network (e.g., the Internet) via an access network. In some embodiments, a LAN may be a wireless local area network (WLAN), which includes, e.g., wireless STAs connected through a wireless AP, e.g., a wireless router. In some embodiments, STAs within a LAN can be, but are not limited to a tablet, a desktop computer, a laptop computer, a handheld computer, a smartphone, or a combination of any these data processing devices or other data processing devices.

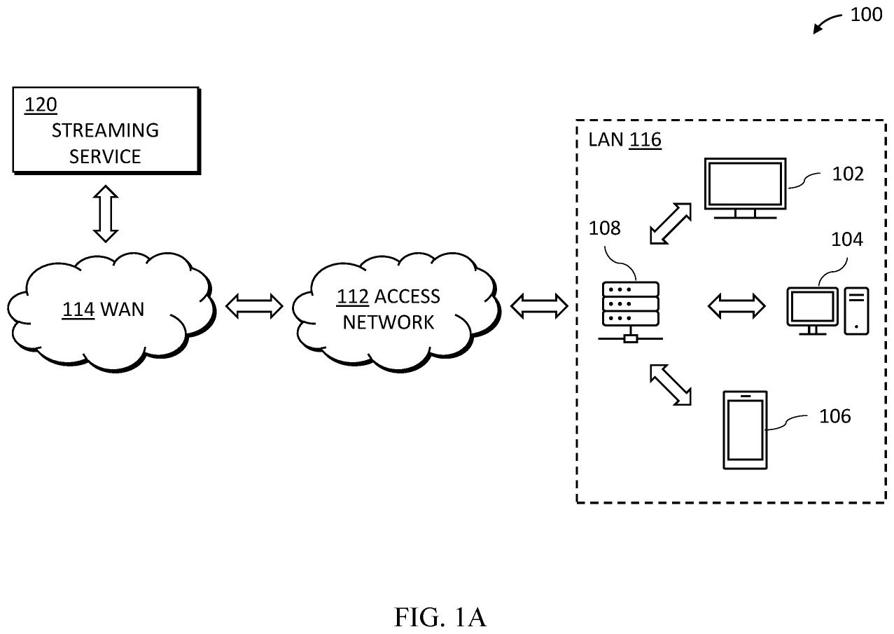

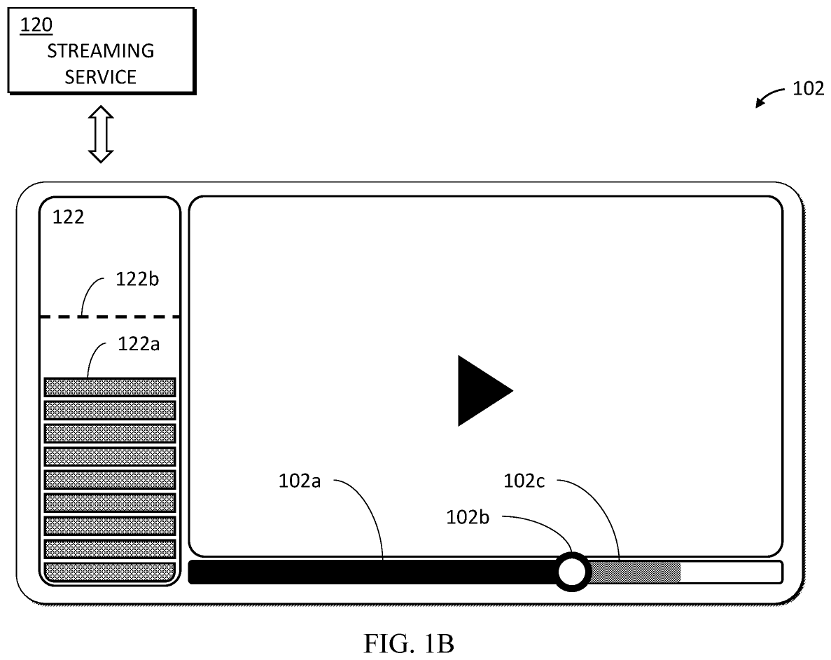

FIG. 1A illustrates an exemplary streaming network environment 100 between an end-station and a streaming service platform 120, in which the present technique for real-time monitoring and evaluating of the overall quality of a streaming media service connection may be realized, according to some embodiments of the present disclosure.

Streaming network environment 100 includes one or more streaming media devices, e.g., end-stations (STAs) 102 (a television set), 104 (a desktop or streaming computer) and/or 106 (a smartphone), communicably connected to streaming media service platform 120 via local area network (LAN) 116, access network 112 and wide area network 114. However, each of STAs 102-106 can represent other forms of computing devices, e.g., a laptop computer, any handheld device, a tablet, a cellular telephone, a smartphone, a network appliance, a camera, a media player, a navigation device, or a combination of any these devices.

LAN 116 includes AP 108 and STAs 102-106. LAN 116 may be connected with the access network via a broadband modem. LAN 116 can include any computer network that covers a limited geographic area (e.g., a home, school, computer laboratory, or office building) using a wired or wireless (WLAN) distribution method. Client devices (e.g., STAs 102-106) may associate with an AP (e.g., AP 108) to access LAN 116 using any suitable communication protocol or standard. For example, LAN 116 may be a WLAN, e.g., a Wi-Fi network.

For exemplary purposes, LAN 116 is illustrated as including multiple STAs 102-106; however, LAN 116 may include only one of STAs 102-106. In some implementations, LAN 116 may be, or may include, one or more of a bus network, a star network, a ring network, a relay network, a mesh network, a star-bus network, a tree or hierarchical network, and the like.

AP 108 can include a network-connectable device, such as a hub, a router, a switch, a bridge, or any other access point. The network-connectable device may also be a combination of devices, such as a Wi-Fi router that can include a combination of a router, a switch, and an AP. Other network-connectable devices can also be utilized in implementations of the subject technology. AP 108 can allow client devices (e.g., STAs 102-106) to connect to wide area network 114 via access network 112.

In some aspects, STAs 102-106 may communicate through a communication interface (not shown), which may include digital signal processing circuitry where necessary. The communication interface may provide for communications under various modes or protocols, for example, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, for example, using a Bluetooth, Wi-Fi, or other such transceiver.

Streaming media service platform 120 may be a system or device having a processor, a memory, and communications capability for providing content and/or services to the STAs in the streaming and/or other and/or additional service categories. In some example aspects, streaming media service platform 120 can be a single computing device, for example, a computer server. In other embodiments, streaming media service platform 120 can represent more than one computing device, e.g., multiple servers, working together to perform the actions of a streaming media service platform (e.g., using cloud computing). Further, streaming media service platform 120 can represent various forms of internet service platform including, but not limited to, an application server, a proxy server, a network server, an authentication server, an electronic messaging server, a content server, a server farm, etc.

A user may interact with the content and/or services provided by streaming media service platform 120 through a client application installed at STAs 102-106. Alternatively, the user may interact with the system through a web browser application at STAs 102-106. Communication between STAs 102-106 and streaming media service platform 120 may be facilitated through LAN 116, access network 112 and/or wide area network 114.

Access network 112 can include, but is not limited to, a cable access network, public switched telephone network, and/or fiber optics network to connect wide area network 114 to LAN 116. Access network 112 may provide last mile access to the Internet. Access network 112 may include one or more routers, switches, splitters, combiners, termination systems, central offices for providing broadband services.

Wide area network 114 can include, but is not limited to, a large computer network that covers a broad area (e.g., across metropolitan, regional, national or international boundaries), for example, the Internet, a private network, a cellular network, or a combination thereof connecting any number of mobile clients, fixed clients, and servers. Further, wide area network 114 can include, but is not limited to, any of the following network topologies, including a bus network, a star network, a ring network, a mesh network, a star-bus network, tree or hierarchical network, and the like. Wide area network 114 may include one or more wired or wireless network devices that facilitate device communications between STAs 102-106 and streaming media service platform 120, such as switch devices, router devices, relay devices, etc., and/or may include one or more servers.

Using the example of streaming network environment 100, a typical streaming media service connection includes downstream data packets originating in streaming media service platform 120, and transmitted over WAN 114 and routed to AP 108 via access network 112. AP 108 is connected to a streaming device, e.g., television set 102 (or any other device performing as a television set, for example desktop computer 104 or laptop computer 106).

FIG. 1B illustrates an exemplary playback buffering instance which may be realized using any one of the STAs shown in FIG. 1A, such as STA 102 (a television set). The playback buffering instance can be used to reduce interruptions in video playback, caused due to fluctuations in the incoming network bitrates. Buffer 122 is a region of a memory storage associated with STA 102. Buffer 122 is used to temporarily store a fluctuating level of buffering data 122a (indicated by the number of bars within buffer 122), while it is being received from a streaming media service (such as streaming media platform 120 in FIG. 1A), over an internet connection delivery path. Typically, the buffering data 122a is stored in buffer 122 as it is received from the source and before it is sent to the playback instance over STA 102. With playback buffering, the client device buffers the received video for some time before playing it out at the normal playback rate. When buffering data 122a reaches a specified threshold level 122b within buffer 122, playback can begin (or resume if interrupted). Typically, the playback instance over STA 102 will include a graphical representation bar 102a of the playback and buffering status, showing the current point in the playback indicated by 102b, and the amount of data 102c already loaded in the buffer and waiting to be played back. Over the life of the video playback, the actual amount of buffered data 122a varies, increasing when the incoming rate is greater than the video playback rate, and decreasing when the incoming rate is less than the video playback rate. However, as long as the buffer does not drain completely, the video playback can proceed smoothly, without interruption. It stands to reason that using a larger buffer will tend to prevent the buffer from draining completely and interrupting playback. However, increasing the size of the buffer results in a proportional increase in the time that the user must wait for the buffer to fill up and playback to begin. Thus, there is a fundamental trade-off between the negative effect on the viewer's quality of experience (QoE) caused by delays when waiting for a video to buffer, and the negative effect on QoE caused by playback interrupts.

With continued reference to FIG. 1B, a typical streaming session begins with an initial surge of data, where a new media segment is requested. During this phase, an initial filling of the buffer 122 is achieved, where the download data streaming rate is higher than the video bitrate. This stage quickly fills the buffer 122 with buffering data 122a to a specified level 122b, for example, equal to a certain playback time period (such as 60, 90, 120 seconds, of playback time or more). Once this target is reached, this may be followed by a buffering steady-state, in which the streaming rate approximately matches the video bitrate, keeping the buffer level generally stable. The buffering steady-state may have short packet download bursts followed by idle data transmission periods. In some cases, due to the dynamic connection conditions and the presence of various bottlenecks in the content delivery system, channel throughput may drop below the video bitrate during streaming. Thus, the client device tries to download data, but this is not sufficient to support the current video bitrate, and thus the buffer level begins to decrease (a buffer depleting state). In such cases, in order to avoid a forthcoming video stall by letting the buffer run completely empty, the client device may switch to a lower video quality with an average bitrate below the current throughput, leading to a second filling state and a subsequent steady-state. After the entire content is transmitted, the session ends by playing-out the remaining bits from the buffer.

Accordingly, the present technique is based on the insight that a streaming status of a connection may be evaluated based, at least in part, on a combination of:
Metrics associated with the frequency and duration of periods of content buffering within a time window, indicating whether the buffer is in an initial-filling, an ongoing buffering state, or an idle state (e.g., no data transmission, or data transmission below a predefined threshold level).
Metrics associated with variations or fluctuations in the connection data rate (e.g., byterate), e.g., the standard deviation of the data rate, across the time window.
Metrics associated with the packet loss rate across the time window.

In a non-limiting example, the present technique provides for modifying an online streaming media network, such as exemplary streaming network environment 100, to incorporate the present technique. For example, an agent of the present disclosure may be added to streaming network environment 100 to obtain the desirable features the present disclosure. In some embodiments, an agent of the present disclosure may be integrated as a node of streaming network environment 100, for example, within access network 112, AP 108, or otherwise. The present agent monitors and analyzes the telemetry data over a streaming media service connection, to determine a set of features associated with the service connection. The agent then assigns a score to the connection, based on the determined features.

Accordingly, in some embodiments, the present technique provides for an agent which continuously monitors a streaming media service instance (which may comprise one or more individual data connections) over an online streaming network, to continuously evaluate the telemetry data performance of the network path from sender to target. In some embodiments, the present technique provides for monitoring a streaming network path throughput, bandwidth, response time, and/or latency, to determine a plurality of parameters associated with the amount of time required for a packet to travel across a network path from sender to target in both ways.

In some embodiments, the present technique specially measures the following parameters:
Data rate or byterate: The maximum amount of data that can be transmitted over a link or connection between two points in a communication network, which may be measured in bits per second (bps) or in bytes per second (8 bits per second), sometimes with a multiplier, such as K (for thousands), M (for millions), or G (for billions).
Packet loss: The rate of dataframe loss, i.e., dataframes that should have been forwarded by a network but did not reach their destination. Packet loss may be detected by comparing sequential numbers of downstream control packets sent to client and sequential numbers extracted from upstream packets received from client. The ratio of the number of lost packets to the number of downstream control packets defined a packet-loss ratio.

In some embodiments, the present technique uses these parameters to calculate and assign an Overall Quality Score to the streaming media service instance. In some examples, the service instance quality score can be represented on a scale of between 0-100, or using any other suitable scoring scale. In some embodiments, the service instance quality score may then allow the present technique to assess an overall Quality of Experience (QoE) associated with the streaming media service instance, based on a scoring scale of 0-100:
Satisfactory Status (Score 75-100): The gaming service instance provides a satisfactory level of QoE.
Advisory Status (Score 50-74): The gaming service instance generally provides an adequate level QoE, however, the QoE is unstable and may be negatively impacted in the case of an increase in network data traffic or similar factors.
Critical Status (Score 25-49): The gaming service instance provides an inadequate level of QoE.
Inoperative Status (Score 0-24): The streaming media service instance is inoperative, such that an end-deice is unable to connect to a streaming platform, experiences frequent disconnections, and/or is unable to execute a streaming application which requires a real-time data connection.

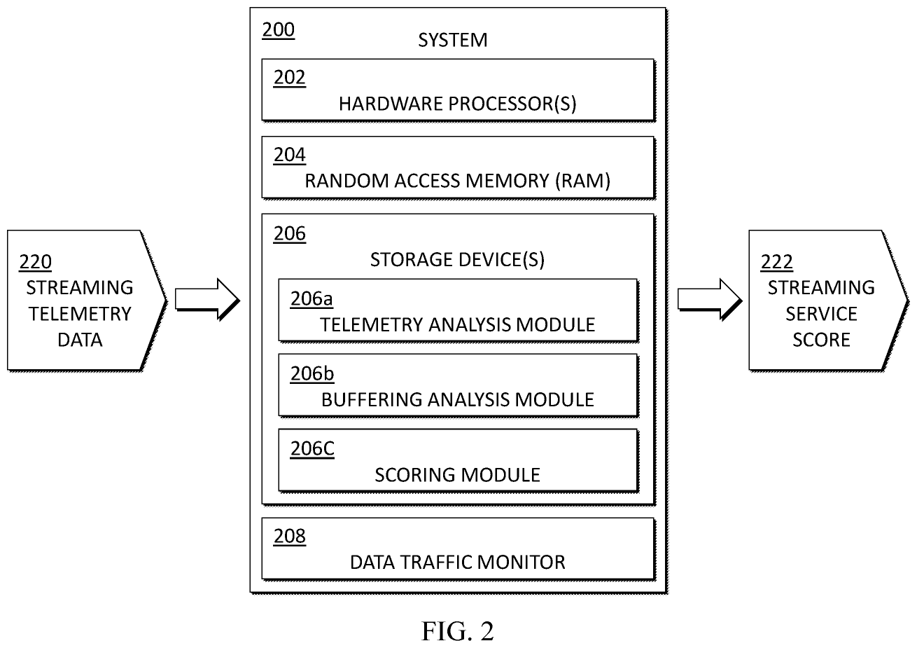

FIG. 2 shows a block diagram of an exemplary system 200 for real-time monitoring and evaluating of the overall quality of a streaming media service connection, according to some embodiments of the present disclosure.

System 200 may include one or more hardware processor(s) 202, a random-access memory (RAM) 204, one or more non-transitory computer-readable storage device(s) 206, and a data traffic monitor 208. Components of system 200 may be co-located or distributed, or the system may be configured to run as one or more cloud computing ‘instances,’ ‘containers,’ ‘virtual machines,’ or other types of encapsulated software applications, as known in the art.

Storage device(s) 206 may have stored thereon program instructions and/or components configured to operate hardware processor(s) 202. The program instructions may include one or more software modules, such as telemetry analysis module 206a, buffering analysis module 206b, and scoring module 206c. The software components may include an operating system having various software components and/or drivers for controlling and managing general system tasks (e.g., memory management, storage device control, power management, etc.), and facilitating communication between various hardware and software components. System 200 may operate by loading instructions of the various software module 206a, buffering analysis module 206b, and/or scoring module 206c into RAM 204 as they are being executed by processor(s) 202.

Data traffic monitor 208 may be configured to continuously monitor one or more streaming service instances over data communication networks. Data traffic monitor 208 may monitor and capture streaming telemetry data 220, including, but not limited to, data packets, user data, or control information associated with various information channels (e.g., control channels, data channels, and information related to managing service discovery over network connections). Streaming telemetry data 220 received at data traffic monitor 208 may be defined as a packet flow, e.g., a series of data packets sharing the same source node e.g., streaming service 120) and destination IP addresses (e.g., associated with a video client software running on a device such as STA 102-106), IP ports and transport protocol. Streaming telemetry data 220 received at data traffic monitor 208 may be processed and transmitted to telemetry analysis module 206a and/or to other components of system 200.

In some embodiments, data traffic monitor 208 may monitor and capture telemetry data, captured through active and/or passive probing of endpoint devices. In some embodiments, probing by data traffic monitor 208 may entail sending one or more of the following probes:
DHCP probes with helper addresses.
SPAN probes, to get messages in INIT-REBOOT and SELECTING states, use of ARP cache for IP/MAC binding, etc.
Netflow probes.
HTTP probes to obtain information such as the OS of the device, Web browser information, etc.
RADIUS probes.
SNMP to retrieve MIB object or receives traps.
DNS probes to get the Fully Qualified Domain Name (FQDN).
Active or SNMP scanning to retrieve the MAC address of a device or other types of information.

In some embodiments, telemetry data captured by data traffic monitor 208 may also include data packets, user data, or control information associated with various information channels (e.g., control channels, data channels, and information related to managing service discovery over network connections). Information received at data traffic monitor 208 may be processed and transmitted to telemetry analysis module 206a and/or to other components of system 200.

In some embodiments, data traffic monitor 208 may be completely software based, hardware based, or a combination of both. Data traffic monitor 208 may comprise one or more monitoring points, which may be implemented in software and/or hardware devices distributed over a plurality of network nodes. In some cases, data traffic monitor 208 may be implemented by a vendor, such as an ISP, to monitor network data traffic over a backbone or access network, where the data traffic is associated with a plurality of LANs serviced by the ISP.

In some embodiments, input streaming telemetry data 220 captured by data traffic monitor 208 originate in wired networks, but can also originate in wireless networks and virtual environments. In some examples, data traffic monitor 208 may include a circuit or circuitry for monitoring and identifying one or more attributes of a connection. In some embodiments, data traffic monitor 208 may be configured to monitor and determine, e.g., connection throughput (e.g., connection data rate or byterate, packets per second, etc.). In some embodiments, data traffic monitor 208 may comprise a ‘sniffer’ or network analyzer designed to capture packet data on a network. In some embodiments, data traffic monitor 208 may employ any suitable hardware and/or software tool to capture data traffic samples. For example, data traffic monitor 208 may be deployed to monitor one or more access networks, access points, end devices, and/or hosts, to capture data packets sent to or received from the Internet. In some embodiments, data traffic monitor 208 may be configured to determine a corresponding source or application associated with each captured data packet. In some embodiments, data traffic monitor 208 may be configured to timestamp each received packet, and to label each received packet with its associated source or application.

In some embodiments, telemetry analysis module 206a may be configured to receive input streaming telemetry data 220, as captured by data traffic monitor 208, and to preprocess and/or process and analyze the input streaming telemetry data 220 according to any desirable or suitable analysis technique, procedure or algorithm. In some embodiments, telemetry analysis module 206a may be configured to perform any one or more of the following: data cleaning, data filtering, data normalizing, and/or feature extraction and calculation.

In some embodiments, buffering analysis module 206b is configured to divide streaming telemetry data 220 into consecutive buffering-related segments, to categorize each of the segments into one of a set of categories, and to calculate statistical metrics over each of the buffering-status segments.

In some embodiments, scoring module 206c is configured to continuously calculate and output an Overall Quality Score 222 associated with a current streaming media service instance.

System 200 as described herein is only an exemplary embodiment of the present invention, and in practice may be implemented in hardware only, software only, or a combination of both hardware and software. In various embodiments, system 200 may comprise a dedicated hardware device, or may be implement as a hardware and/or software module into an existing device, e.g., an AP, such as AP 108 within LAN 116 shown in FIG. 1A, or may be part of a remote server, e.g., streaming media service platform 120 shown in FIG. 1A. System 200 may have more or fewer components and modules than shown, may combine two or more of the components, or may have a different configuration or arrangement of the components. System 200 may include any additional component enabling it to function as an operable computer system, such as a motherboard, data busses, power supply, a network interface card, a display, an input device (e.g., keyboard, pointing device, touch-sensitive display), etc. (not shown). Moreover, components of system 200 may be co-located or distributed, or the system may be configured to run as one or more cloud computing ‘instances,’ ‘containers,’ ‘virtual machines,’ or other types of encapsulated software applications, as known in the art.

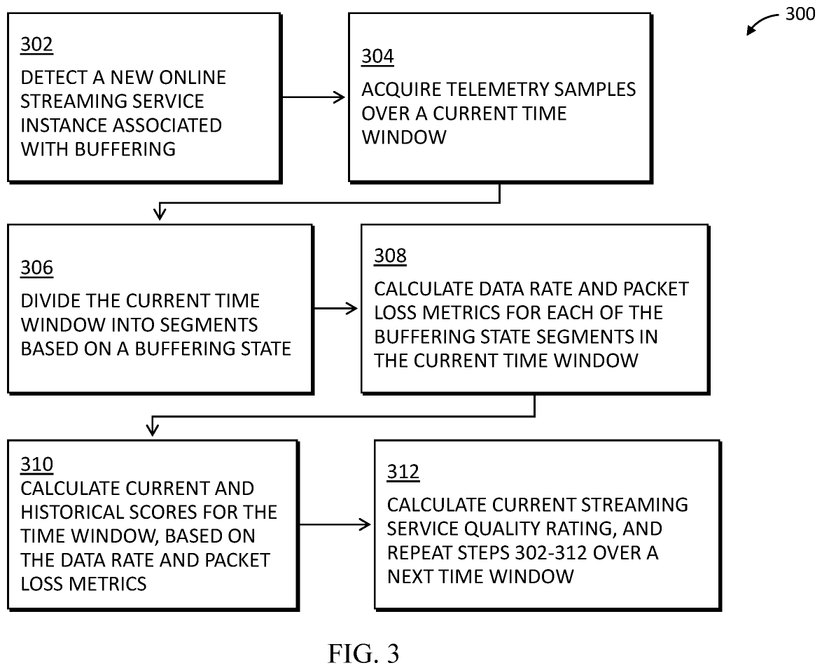

The instructions of system 200 will now be discussed with reference to the flowchart of FIG. 3, which illustrates the functional steps in a method 300 for real-time monitoring and evaluating of the overall quality of a streaming media service connection, according to some embodiments of the present disclosure. The various steps of method 300 will be described with continuous reference to exemplary streaming network environment 100 shown in FIG. 1A, the exemplary playback buffering system shown in FIG. 1B, and to exemplary system 200 shown in FIG. 2.

The various steps of method 300 may either be performed in the order they are presented or in a different order (or even in parallel), as long as the order allows for a necessary input to a certain step to be obtained from an output of an earlier step. In addition, the steps of method 300 may be performed automatically (e.g., by system 200 of FIG. 2), unless specifically stated otherwise. In addition, the steps of FIG. 3 are set forth for exemplary purposes, and it is expected that modification to the flow chart is normally required to accommodate various network configurations and network carrier business policies.

In some embodiments, the steps of method 300 may be performed recursively, over consecutive time windows, over all or part of the duration of an online streaming service instance. In some embodiments, the time windows have a duration of, e.g., between 1-240 seconds. However, other time windows having durations that are shorter or longer may be used. In some embodiments, the time windows over which the steps of method 300 are performed recursively may partly overlap.

Method 300 begins in step 302, when an end-user transmits a streaming media instance request. For example, with reference to FIG. 1A, an end-user using STA 102 (a television set) within LAN 116 may transmit a request to establish a new streaming media service connection with streaming media service platform 120.

In some cases, the streaming media service resources may be deployed across one or more associated domains, e.g., multiple domains. In such cases, in order to fetch the service, STA 102 must open two or more parallel data connections associated with the multiple resources comprising the requested service. Thus, a streaming media service connection may comprise multiple active connections collectively providing a single streaming media service instance.

In some embodiments, the instructions of data traffic monitor 208 may cause system 200 to detect a new streaming media service instance which includes one or more data traffic connections established within the context of the streaming network environment. As an example, system 200 or a portion thereof may be implemented, e.g., as a dedicated hardware device, or may be implement as a hardware and/or software module into an existing device, e.g., an AP, such as AP 108 within LAN 116 shown in FIG. 1A, or may be part of a remote server, e.g., streaming media service platform 120 shown in FIG. 1A. Specifically, the instructions of data traffic monitor 208 may cause system 200 to detect a new streaming media service instance, and to continuously monitor the one or more data connections associated with the streaming media service instance.

In some embodiments, the instructions of data traffic monitor 208 may cause system 200 to determine whether the service instance is associated with streaming media. For example, system 200 may be configured to determine that a new service instance is associated with online streaming based on connection parameters such as, but not limited to, domain name, IP address, and/or port numbers. In some embodiments, system 200 may perform these checks with respect to the multiple data connections in the service instance. In some embodiments, system 200 may be configured to determine that a new service instance is associated with online streaming media based on a trained machine learning model classifier configured to output a classification of a target data traffic flow as belonging to one or more specified service categories, e.g., streaming media.

In some embodiments, a domain name may be determined using a Secure Socket Layer (SSL) certificate, which provides a fully qualified domain name associated with a server as verified by a trusted third party service. For example, a reverse DNS lookup or reverse DNS resolution (rDNS) may be carried out by data traffic monitor 208 to determine the domain name associated with an IP address. In other examples, data traffic monitor 208 may determine port numbers associated the IP address, and/or a transport protocol, e.g., Transmission Control Protocol (TCP) and the User Datagram Protocol (UDP). In the case of port number ranges, because many Internet resources use a known port or port ranges on their local host as a connection point to which other hosts may initiate communication, data traffic monitor 208 may analyze TCP SYN packets to know the server side of a new client-server TCP connection.

In some embodiments, associating a service instance with streaming media may be based on a URL or a server IP address associated with a known domain found, e.g., in repository of domain names associated with streaming media. For example, known domain names associated with streaming media may be identified and added to a database of domain name maintained by system 200, e.g., on storage device 206. In some embodiments, such detection may be further supported by, e.g., an expression or a string (e.g., a regex) which may be associated with a particular streaming application or service provider, an expected port range associated with the service type, or an expected protocol associated with the service provider.

In some embodiments, a database of known domain names associated with streaming media online may be obtained using, e.g., a dedicated crawler configured to systematically browses the Internet for the purpose of identifying and indexing domain names based on a type, content, etc. A crawler typically travels over the Internet and accesses resources. The crawler inspects, e.g., the content or other attributes of resources. The crawler then follows hyperlinks to other resources. The results of the crawling are then extracted into a repository, which may be queried to find content that is relevant to a particular task. Thus, for example, a URL or IP address associated with a service being provided to an STA in LAN 116 may be matched with an entry in a domain repository maintained by system 200. In such case, the service may be determined to be a category of service associated with the matched domain name.

In some embodiments, system 200 may be configured to determine that a new service instance is associated with online streaming by applying one or more trained machine learning models configured to perform a classification task which classifies input telemetry data as associated with online streaming media service.

With reference back to FIG. 3, in step 304, the instructions of data traffic monitor 208 and/or telemetry analysis module 206a may cause system 200 to capture telemetry data samples over the current time window, from the one or more data connections associated with the streaming service instance identified in step 302.

In some embodiments, step 304 may comprise acquiring telemetry samples and related data over one of, some of, or all of, the data connections comprising the current streaming media service instance detected in step 302. Thus, in some embodiments, the instructions of data traffic monitor 208 may cause system 200 to continuously sample any one, some, or all of the data connections comprising the streaming service instance, to capture telemetry data. In some embodiments, the instructions of data traffic monitor 208 may cause system 200 to sample any one, some, or all of the data connections comprising the streaming service instance at a specified sampling interval of between 0.1-240 seconds, for example, every 2 seconds, or at any other desired sampling interval.

In some embodiments, the instructions of data traffic monitor 208 may cause system 200 to identify, with respect to a current time window, a subset comprising one or more of the most active data connections, from among the data connections which may be associated with the streaming service instance detected in step 302. In some embodiments, the instructions of data traffic monitor 208 may cause system 200 to select only the single most active data connection for telemetry sampling. In some embodiments, the instructions of data traffic monitor 208 may cause system 200 to select the top two most active data connections for telemetry sampling. In some embodiments, the instructions of data traffic monitor 208 may cause system 200 to select another specified number of the most active data connections for telemetry sampling, such as between 3-8 data connections.

In some embodiments, selecting the most active data connections may be based, at least in part, on maximum and/or average data traffic measured over each individual data connection making up the streaming service instance. In some embodiments, the data traffic may be measured in bits per second, bytes per second, and/or packets per second.

In some embodiments, the instructions of data traffic monitor 208 may cause system 200 to capture telemetry samples over the current time window representing data traffic rates over one or more data connections (which may be a subset comprising only the one or more most active data connections, as detailed hereinabove). In some embodiments, data rates may be measured in bit per second, bytes per second, or packets per second. In some embodiments, these measurements may be performed at specified sampling intervals of between, e.g., 0.01-240 seconds, or at any other desired sampling interval. In some embodiments, the instructions of data traffic monitor 208 may cause system 200 to store the results of the data rate measurements, e.g., in a repository on storage device 206.

In some embodiments, in step 304, the instructions of data traffic monitor 208 may cause system 200 to capture telemetry samples over the current time window representing packet loss rates over one or more data connections (which may be a subset comprising only the one or more most active data connections, as detailed hereinabove). In some embodiments, packet loss may be measured as a rate of dataframe loss, i.e., the percentage of dataframes that should have been forwarded by a network but were not.

In some embodiments, packet loss rate may be estimated based on a ping and/or traceroute tests. A ping utility indicates whether a specified destination server is reachable and the time it will take to send and receive data from the server. Ping and/or similar utilities work by sending Internet Control Message Protocol (ICMP) echo request packets to at least one IP address associated with streaming service platform 120. The ping utility measures the round-trip time for messages sent from the originating node to a destination computer. If an echo reply packet is not received within a defined time period, connectivity to that device is assumed to be down. Traceroute and/or similar utilities work by sending packets of data with a low survival time (Time to Live—TTL) which specifies how many steps (hops) can the packet survive before it is returned. When a packet cannot reach the final destination and expires at an intermediate step, that node returns the packet and identifies itself. Thus, by increasing the TTL gradually, the trace is able to identify the intermediate hosts. If any of the hops comes back with a “request timed out,” this may denote network congestion and a reason for slow loading Web pages and dropped connections.

Thus, for example, packet loss rate measurements may be based on a ratio of ping and/or traceroute messages that failed to reach their destination and/or timed-out. Accordingly, if 100 ping and/or traceroute tests are conducted within a specified time window, but only 70 were received by their respective destination, this indicated a packet loss rate of 30%. In some embodiments, the packet loss measurements over the data connections may be performed continuously. In each such case, the ping tests may be performed repeatedly. For example, the ping tests may be repeated at intervals of between seconds over the current time window, or at any other desired interval over the current time window. In some embodiments, the instructions of data traffic monitor 208 may cause system 200 to continuously acquire and store, in real time, the results of the ping test measurements over the current time window with respect to the one or more data connections, e.g., in a repository on storage device 206.

In some embodiments, step 304 may be carried out by data traffic monitor 208, which may be configured to continuously determine one or more data traffic parameters associated with the one or more data connections comprising the streaming media service instance detected in step 302. The data traffic parameters may be obtained, e.g., from packet header information (obtained either through operating system files or data traffic sniffing), including, e.g., the IP source, destination, and port numbers. In the case of port number ranges, because many Internet resources use a known port or port ranges on their local host as a connection point to which other hosts may initiate communication, data traffic monitor 208 may analyze TCP SYN packets to know the server side of a new client-server TCP connection.

In some embodiments, data traffic monitor 208 may be configured to continuously capture streaming telemetry data associated with a one or more data connections over a data communications network or any other similar communications platform for carrying or transferring data over network links between one or more network nodes (e.g., terminals, gateways, routers, etc.). Such streaming telemetry data may involve a particular service instance for a particular device/client application or client service, such as a streaming media instance. Streaming telemetry data further may be carried or communicated via any of various different data communications protocols, such as Transmission Control Protocol over Internet Protocol (TCP/IP), User Datagram Protocol over IP (UDP/IP), etc., and may also involve other information systems session protocols such as Hypertext Transfer Protocol (HTTP) or Hypertext Transfer Protocol Secure (HTTPS). However, the principles of the example embodiments of the present invention are equally applicable to any network data traffic irrespective of the particular protocols employed.

In some embodiments, the instructions of data traffic monitor 208 may cause system 200 to employ one or more data connection tracking tools, to determine such data traffic parameters, measurements and/or statistics of the connection. In some embodiments, such tools may provide such information with respect to application protocols such as FTP, TFTP, IRC, and PPTP. In some embodiments, such tools provide the ability to monitor and handle data packets at different stages, e.g., pre-routing, local input, forward, local output, and/or post-routing.

With reference back to FIG. 3, in step 306, the instructions of buffering analysis module 206b may cause system 200 to divide the streaming telemetry data over a current time window into buffering-status segments, i.e., based on a detected change in a buffering state in the streaming telemetry data. For example, the instructions of buffering analysis module 206b may cause system 200 to analyze data rate and related parameters associated with the streaming service instance detected in step 302, as well as the state of a buffer (such as buffer 122 of STA 102 shown in FIG. 1B) associated with the streaming service instance.

In some embodiments, the instructions of buffering analysis module 206b may cause system 200 to assign each of the buffering-status segments into one of the following categories:
Unknown: The category of the buffering state segment cannot be determined by buffering analysis module 206b.
Initial Buffering: An initial stage in which buffer 122 is filling up at the beginning of the streaming service instance, with a surge of data immediately before playback begins. This stage is designed to fill the buffer to a certain level, such as level 122b, which may be equal to a certain playback time period (such as 120 seconds).
Ongoing Buffering: Periods of buffer 122 filling up during playback. This occurs, for example, when channel throughput (data rate) drops below the actual video playback bitrate during streaming, and thus is insufficient to support the current video bitrate. This may lead to a switch by STA 102 to a lower video quality mode, to lower the average bitrate below the current throughput, which may result in buffer 122 filling up.
Idle: No data transmission over the data connections, or data transmission below a specified threshold level.

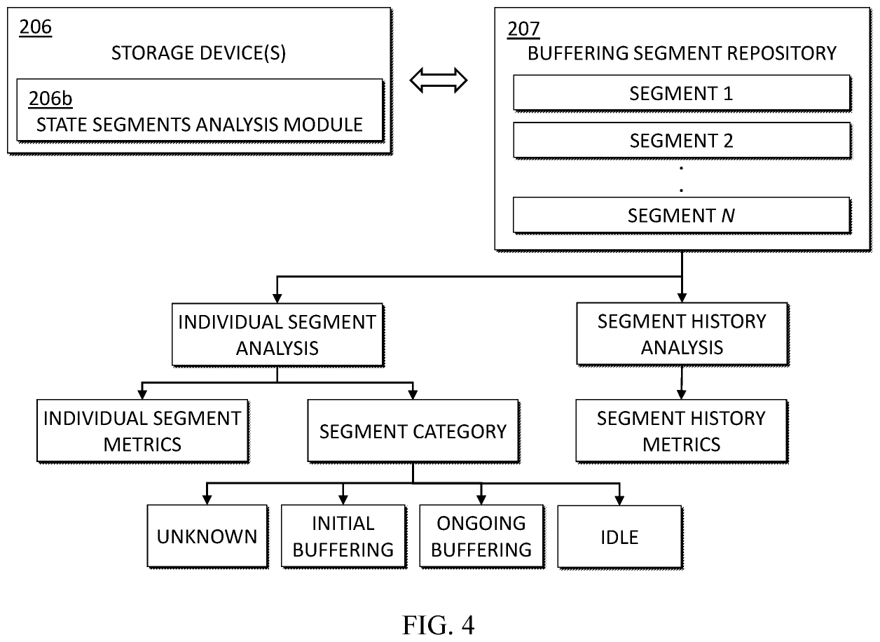

FIG. 4 shows an exemplary buffering segment repository 207 of the present technique, which may be stored on storage device 206 and managed by buffering analysis module 206b. In some embodiments, buffering segment repository 207 stores a cumulative database of all buffering state segments identified by buffering analysis module 206b for at least the current streaming media service instance. In some embodiments, buffering analysis module 206b may continuously perform analyses and store analyses results with respect to the database of buffering state segments stored in buffering segment repository 207, including, but not limited to:
Individual buffering state segment category;
individual state statistical metrics (as further detailed below with reference to step 308 of method 300); and/or
buffering state segments database statistical metrics (as further detailed below with reference to step 308 of method 300).

In some embodiments, buffering analysis module 206b may cause system 200 to store, e.g., in buffering state segments repository on storage device 206 (as shown in FIG. 4), data related to the at least some of the buffering-status segments identified and classified during the current streaming service instance detected in step 302. In some embodiments, buffering analysis module 206b may cause system 200 to store for each buffering-status segment, at least the buffering-status segment category, segment duration, total number of bytes transmitted during the segment, and total number of packets transmitted during the segment. Table 1 below shows exemplary streaming buffering state segment data as may be detected and stored by buffering analysis module 206b in buffering segment repository 207, with respect to any one, some, or all of the data connections associated with a streaming service instant.

TABLE 1
Exemplary Streaming Buffering state segment Data

| BUFFERING STATE | | | |
|---|---|---|---|
| SEGMENT TYPE | DURATION (Sec) | BYTES | PACKETS |
| Initial buffering | 1 | 624495 | 458 |
| Idle | 2 | 0 | 0 |
| Ongoing Buffering | 1 | 2020968 | 1473 |
| Idle | 9 | 0 | 0 |
| Ongoing Buffering | 1 | 2013314 | 1468 |
| Idle | 5 | 0 | 0 |
| Ongoing Buffering | 1 | 620749 | 455 |
| Idle | 3 | 0 | 0 |
| Ongoing Buffering | 1 | 2017459 | 1472 |
| Idle | 10 | 0 | 0 |
| Ongoing Buffering | 1 | 2033482 | 1488 |
| Idle | 4 | 0 | 0 |
| Ongoing Buffering | 1 | 616059 | 455 |

In some embodiments, in step 308, buffering analysis module 206b may cause system 200 to calculate data rate and packet loss over each of the buffering-status segments comprising the current time window, based on the telemetry data acquired in step 304.

In some embodiments, these metrics may be calculated over each of the buffering-status segments comprising the current time window, as determined by buffering analysis module 206b in step 306. In some embodiments, buffering analysis module 206b may cause system 200 to use the data rate and packet loss measurements acquired in step 304 to calculate at least some of the following metrics:
Mean, average, maximum, minimum, and standard deviation of the byterate in each buffering-status segment.
mean, average, maximum, minimum, and standard deviation of the packet rate in each buffering-status segment.
mean, average, maximum, minimum, and standard deviation of packet roundtrip time.
mean, average, maximum, minimum, and standard deviation of packet loss rate in each buffering-status segment.
mean, average, maximum, minimum, and standard deviation of the duration of all buffering-status segments of “ongoing buffering” and/or “initial buffering” categories.

In step 310, the instructions of scoring module 206c may cause system 200 to calculate a plurality of ratings over the current time window, based, at least in part, on the buffering-status segments classified in step 306 and the metric calculated in step 308.

In some embodiments, the instructions of scoring module 206c may cause system 200 to further calculate a current Overall Quality Score of the streaming service session, based on the plurality of calculated ratings. In some embodiments, the Overall Quality Score of the streaming service session may be based, at least in part, on:
The relative proportion of data buffering and idle periods over the current time window.
The relative proportion of data buffering and idle periods over some or all of the preceding time windows within the current streaming service instance.

In some embodiments, the instructions of scoring module 206c may cause system 200 to calculate, with respect to the current time window, at least one of:
(i) Current Time Window Buffering Score: The Current Time Window Buffering Score is calculated based, at least in part, on the data rate and packet loss metrics (calculated in step 308) associated with (i) the last buffering-status segment ending within the current time window, and (ii) the longest buffering-status segment (i.e., assigned a category of initial buffering or an ongoing buffering segment) ending within the current time window.
(ii) Historical Buffering Score: The Historical Buffering Score is calculated based, at least in part, on the data rate and packet loss metrics associated with all of the buffering-status segments (i.e., segments assigned a category of initial buffering and/or ongoing buffering) within the current streaming service instance detected in step 302, as may be stored in buffering segment repository 207.

The Current Time Window Buffering Score is generally based on the ‘worst’ buffering segment within the current time window, in terms of its duration and mean data rate. These metrics may be indicators of the general health of the network and the recent experience of the user. When network performance deteriorates, the duration of buffering states can increase, along with a decrease in the data rate. In addition, the Current Time Window Buffering Score is based on the performance of the most-recent buffering-status segment within the current time window. If the most recent segment had a buffering status (i.e., assigned a category of initial buffering and/or ongoing buffering), data rate and packet loss metrics are used to determine the health of the network and the most recent experience of the user.

### Current Time Window Buffering Score

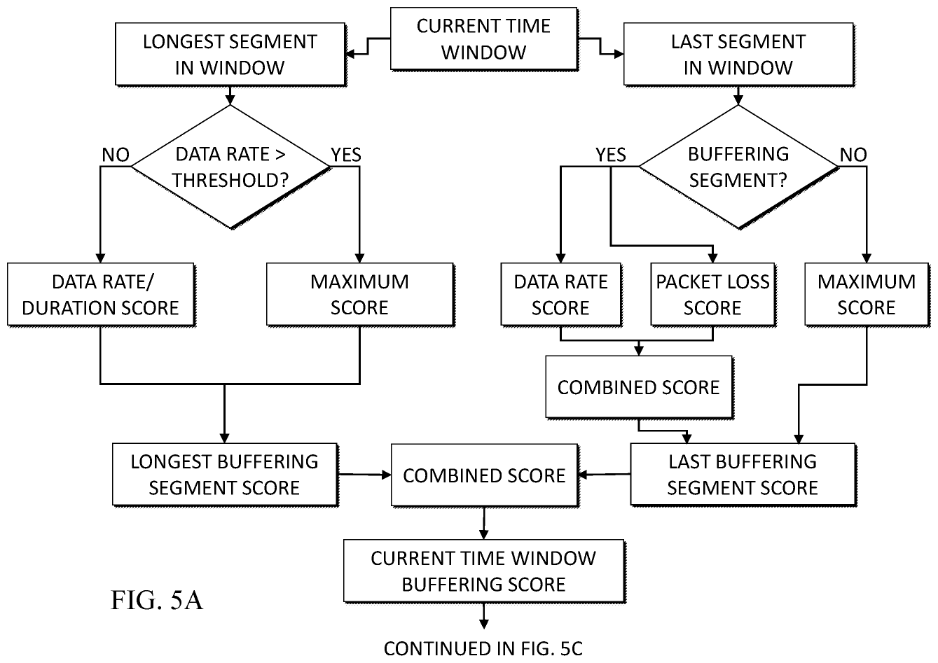

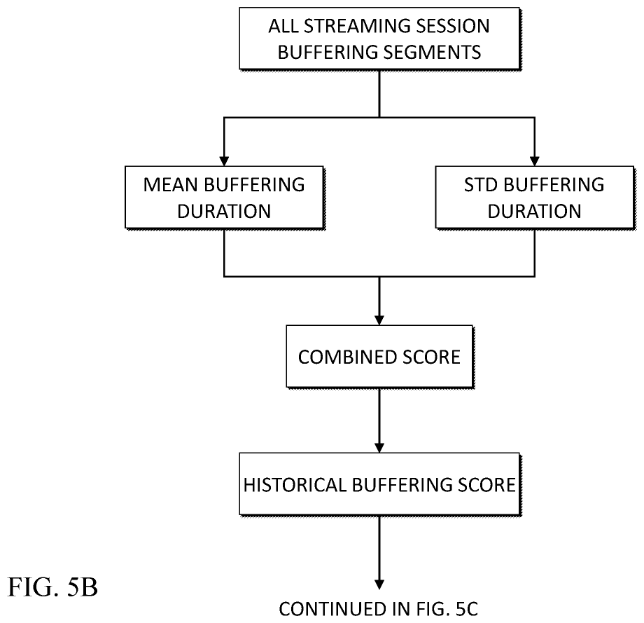

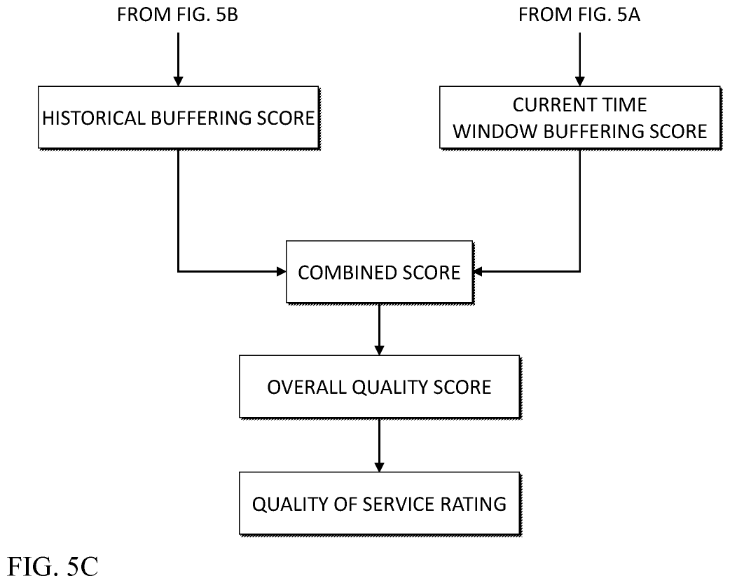

FIG. 5A shows an exemplary Current Time Window Buffering Score calculation, according to some embodiments of the present disclosure. In some embodiments, the Current Time Window Buffering Score calculation is based, at least in part, on data rate and packet loss metrics associated with at least one of:
(i) Last Buffering-Status Segment Score: A score based on the last buffering-status segment ending within the current time window.
(ii) Longest Buffering-Status Segment Score: A score based on the longest buffering-status segment (i.e., assigned a category of initial buffering and/or ongoing buffering) ending within the current time window.

In some embodiments, the Current Time Window Buffering Score has a scale of 0-100, where a score of 100 indicates no detected issues with the current buffering score of the streaming media service instances.

In some embodiments, scoring module 206c is configured to output, as the Current Time Window Buffering Score, a combined score, by applying a predefined function (which may be a minimum function) or predefined weights, to the (i) Last Buffering-Status Segment Score and (ii) Longest Buffering-Status Segment Score. In some embodiments, scoring module 206c is configured to output, as the Current Time Window Buffering Score, the lowest of the (i) Last Buffering-status segment Score and (ii) Longest Buffering-status segment Score.

### Calculation of the Last Buffering-Status Segment Score

In some embodiments, scoring module 206c is configured to calculate a Last Buffering-Status Segment score, based, at least in part, on data rate and packet loss metrics associated with the last of the buffering-status segments within the current tine window, having a duration which exceeds a predefined threshold.

In some embodiments, if the last buffering-status segment ending within the current time window is categorized as a non-buffering-status segment (e.g., assigned a category of ‘unknown’ or ‘idle’), then scoring module 206c may assign a predefined maximum score of 100, or another maximum score as the Last Buffering-Status Segment score.

In some embodiments, if the last buffering-status segment ending within the current time window is categorized as a buffering segment (e.g., assigned a category of ‘initial buffering’ or ‘ongoing buffering’), then scoring module 206c may calculate and assign a Last Buffering-Status Segment Score based on calculating the following two sub-scores:
Data Rate Sub-Score: Calculated by inputting the standard deviation variable of the data rate (e.g., byterate) in the last buffering-status segment ending within the current time window, into a monotonical one-variable function which assigns a score on a scale of 0-100, wherein a score of 100 indicates no data rate (e.g., byterate) variability, or a data rate (e.g., byterate) variability below a minimum specified threshold. This variable was selected because variability or fluctuations in the data rate (e.g., byterate) can result in stops, lags, poor buffering of the content, and deterioration in the quality of the streamed media.
Packet Loss Sub-Score: Calculated by inputting the packet loss rate in the last buffering-status segment ending within the current time window, into a monotonical one-variable function which assigns a score on a scale of 0-100. In some embodiments, a predetermined score (e.g., a minimum overall Packet Loss Sub-Score of 0) may be assigned in cases of a loss rate of 100%, i.e., when virtually all packets are lost. Conversely, another predetermined score (e.g., a maximum overall Packet Loss Sub-Score of 100) may be assigned in cases of a loss rate of 0%, i.e., when virtually all packets reach their destination. This variable was selected because dropped packets result in loss of data on the user side and can have a negative effect on the reconstructed video quality.

In some embodiments, scoring module 206c is configured to output, as the Last Buffering-status segment score, a combined score, by applying a predefined function (which may be a minimum function) or predefined weights, to the data rate (e.g., byterate) and/or packet loss sub-scores. In some embodiments, scoring module 206c is configured to output, as the Last Buffering-Status Segment Score, the lowest of the byterate and packet loss sub-scores.

### Calculation of the Longest Buffering-Status Segment Score

In some embodiments, scoring module 206c is configured to calculate a Longest Buffering-Status Segment Score based, at least in part, on data rate and segment duration metrics associated with a longest buffering-status segment (i.e., the longest segment which was assigned a category of initial buffering and/or ongoing buffering) ending within the current time window.

In some embodiments, the instructions of scoring module 206c may cause system 200 to search for the longest-duration buffering segment which was assigned a category of ‘initial buffering’ or ‘ongoing buffering,’ ending within the current time windows.

If the longest duration buffering-status segment ending within the current time window has a data rate (e.g., byterate) which exceeds a specified threshold, then scoring module 206c may assign a predetermined score (e.g., a maximum score of 100) as the Longest Buffering-status segment Score. If the longest duration buffering-status segment ending within the current time window has a data rate (e.g., byterate) which is below the specified threshold, then scoring module 206c calculates the Longest Buffering-Status Segment Score based, at least in part, on buffering-status segment duration and mean data rate (e.g., byterate) on a scale of 0-100.

### Historical Buffering Score

FIG. 5B shows an exemplary Historical Buffering Score calculation, according to some embodiments of the present disclosure.

In some embodiments, the Historical Buffering Score calculation is based, at least in part, on data rate and packet loss metrics associated with some or all of the time windows preceding the current time window, which comprise the current streaming media service instance, i.e., over part or all of the history of the current streaming media service instance. In some embodiments, the score is based, at least in part, on:
Mean duration of all buffering-status segments in the current streaming media service instance. This variable is input into a single-variable monotonically rising function which assigns a score on a scale of 0-100, wherein a score of 100 indicates no excessive or extended buffering periods over the history of the streaming media service instance.
Standard deviation of the duration of all buffering-status segments in the current streaming media service instance. This variable is input into single-variable monotonically rising function which assigns a score on a scale of 0-100, wherein a score of 100 indicates no excessive or extended buffering score fluctuations over the history of the streaming media service instance.

These variables were selected based on the insight that a healthy network streaming connection should not exhibit extended buffering periods and/or excessively fluctuating buffering states.

In some embodiments, scoring module 206c is configured to output a combined score, by applying a predefined function (which may be a minimum function) or predefined weights, to the (i) mean duration and (ii) standard deviation of the duration, as the Historical Buffering Score. In some embodiments, scoring module 206c is configured to select a lowest of the (i) mean duration and (ii) standard deviation of the duration, as the Historical Buffering Score. In some embodiments, the final score is scaled such that it does not reach zero.

### Calculation of Overall Quality Score and Quality of Experience (QoE) Rating

FIG. 5C shows an Overall Quality Score calculation, according to some embodiments of the present disclosure.

With reference back to FIG. 3, in step 312, in some embodiments, scoring module 206c is configured to output a combined score, by applying a predefined function (which may be a minimum function) or predefined weights, to the (i) Current Time Window Buffering Score and (ii) Historical Buffering Score, as an Overall Quality Score 222 associated with a current streaming media service instance. In some embodiments, scoring module 206c is configured to assign the lowest of the (i) Current Time Window Buffering Score and (ii) Historical Buffering Score, as an Overall Quality Score 222 associated with a current streaming media service instance.

Finally, the instructions of scoring module 206c may cause system 200 to assess, based on the Overall Quality Score 222, an overall Quality of Experience (QoE) rating associated with the streaming media service instance, as one of:
Satisfactory Status (Score 75-100): The streaming media service instance provides good QoE.
Advisory Status (Score 50-74): The streaming media service instance currently provides good QoE, however, the QoE is unstable and may be negatively impacted in the case of an increase in network data traffic or similar factors.
Critical Status (Score 25-49): The streaming media service instance provides inadequate QoE.
Inoperative Status (Score 0-24): The streaming media service instance is inoperative, such that an end-deice is unable to connect to a streaming platform, experiences frequent disconnections, and/or unable to execute a streaming application which requires a real-time data connection.
   Time Windows with Steady Buffering

In some embodiments, if the overall buffering status of the current time window was classified as ‘steady buffering,’ then the instructions of scoring module 206c may cause system 200 to calculate and assign to the current time window a Steady Time Window Score, based on the last buffering-status segment ending within the current time window.

In some embodiments, if the last buffering-status segment ending within the current time window is categorized as a non-buffering-status segment (e.g., assigned a category of ‘unknown’ or ‘steady’), then scoring module 206c may assign a score of 100 to the current time window as the Steady Time Window Score.

In some embodiments, if the last buffering-status segment ending within the current time window is categorized as a buffering-status segment (e.g., assigned a category of ‘initial buffering’ or ‘playback buffering’), then scoring module 206c may calculate and assign a Steady Time Window Score based on calculating two sub-scores:
Data Rate Sub-Score: Calculated by inputting the standard deviation variable of the data rate (e.g., byterate) in the last buffering-status segment ending within the current time window into a monotonical one-variable function which assigns a score on a scale of 0-100, wherein a score of 100 indicates no data rate (e.g., byterate) variability, or a data rate (e.g., byterate) variability below a minimum specified threshold. This variable was selected because variability or fluctuations in the data rate (e.g., byterate) can result in stops, lags, poor buffering of the content, and deterioration in the quality of the streamed media.
Packet Loss Sub-Score: Calculated by inputting the packet loss rate in the last buffering-status segment ending within the current time window into a monotonical one-variable function which assigns a score on a scale of 0-100. In some embodiments, a predetermined score (e.g., a minimum overall Packet Loss Score of 0) may be assigned in cases of a loss rate of 100%, i.e., when virtually all packets are lost. Conversely, another predetermined score (e.g., a maximum overall Packet Loss Score of 100) may be assigned in cases of a loss rate of 0%, i.e., when virtually all packets reach their destination. This variable was selected because dropped packets result in loss of data on the user side and can have a negative effect on the reconstructed video quality.

In some embodiments, scoring module 206c is configured to output, as the Steady Time Window Score, a combined score, by applying a predefined function (which may be a minimum function) or predefined weights, to the data rate (e.g., byterate) and packet loss sub-scores as the Last State Segment Score. In some embodiments, scoring module 206c is configured to output, as the Steady Time Window Score, the lowest of the data rate (e.g., byterate) and packet loss sub-scores.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range-10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A system comprising:
at least one hardware processor; and
a non-transitory computer-readable storage medium having stored thereon program instructions, the program instructions executable by the at least one hardware processor to:
receive, at a communications network interface, telemetry data representing a streaming service instance provided to an end-device by a remote streaming server over the Internet, and
recursively, with respect to each current time window:
(i) divide, based on said telemetry data, said time window into segments, wherein each of said segments is classified based on its buffering status as a buffering segment or a non-buffering segment,
(ii) calculate a current streaming service score, based on said buffering status of at least one of said segments within said current time window, and
(iii) update a quality of service (QoS) rating for said streaming media service instance, based, at least in part, on said current streaming service score.

2. The system of claim 1, wherein (i) said buffering segments include segments representing initial or ongoing buffering representing periods of filling or depleting of a buffer associated with said end-device, and (ii) said non-buffering segments include segments in which said buffering status cannot be determined or segments in which said data rate is below a specified threshold.

3. The system of claim 1, wherein, when said last one of said segments ending within said current time window is classified as a buffering segment, said current streaming service score is equal to a last segment score, calculated as a weighted combination of: (i) a data rate score based on a standard deviation of said data rate metrics in said last one of said segments; and (ii) a packet loss score based on said packet loss rate metrics in said last one of said segments.

4. The system of claim 3, wherein said current streaming service score is further based on a longest segment score, calculated based on said data rate metrics and a time duration value of the longest one of said segments classified as a buffering segment and ending within said current time window.

5. The system of claim 4, wherein said current streaming service score is equal to a current window buffering score calculated as a weighted combination of (i) said last segment score, and (ii) said longest segment score.

6. The system of claim 5, wherein said current streaming service score is further based on an historical buffering score, calculated based on time duration values of at least some of said segments classified as buffering segments in one or more time windows preceding said current time window.

7. The system of claim 6, wherein said historical buffering score is based on: (i) a mean duration score based on a mean time duration, and (ii) a standard deviation score based on a standard deviation, of said some of said segments classified as buffering segments in said one or more time windows preceding said current time window.

8. The system of claim 7, wherein said current streaming service score is calculated as a weighted combination of (i) said current window buffering score, and (ii) said historical buffering score.

9. A computer-implemented method comprising:
receiving, at a communications network interface, telemetry data representing a streaming service instance provided to an end-device by a remote streaming server over the Internet; and
recursively, with respect to each current time window:
(i) dividing, based on said telemetry data, said time window into segments, wherein each of said segments is classified based on its buffering status as a buffering segment or a non-buffering segment,
(ii) calculating a current streaming service score, based on said buffering status of at least one of said segments within said current time window, and
(iii) updating a quality of service (QoS) rating for said streaming media service instance, based, at least in part, on said current streaming service score.

10. The computer-implemented method of claim 9, wherein (i) said buffering segments include segments representing initial or ongoing buffering representing periods of filling or depleting of a buffer associated with said end-device, and (ii) said non-buffering segments include segments in which said buffering status cannot be determined or segments in which said data rate is below a specified threshold.

11. The computer-implemented method of claim 10, wherein, when said last one of said segments ending within said current time window is classified as a buffering segment, said current streaming service score is equal to a last segment score, calculated as a weighted combination of: (i) a data rate score based on a standard deviation of said data rate metrics in said last one of said segments; and (ii) a packet loss score based on said packet loss rate metrics in said last one of said segments.

12. The computer-implemented method of claim 11, wherein said current streaming service score is further based on a longest segment score, calculated based on said data rate metrics and a time duration value of the longest one of said segments classified as a buffering segment and ending within said current time window.

13. The computer-implemented method of claim 12, wherein said current streaming service score is equal to a current window buffering score calculated as a weighted combination of (i) said last segment score, and (ii) said longest segment score.

14. The computer-implemented method of claim 13, wherein said current streaming service score is further based on an historical buffering score, calculated based on time duration values of at least some of said segments classified as buffering segments in one or more time windows preceding said current time window.

15. The computer-implemented method of claim 14, wherein said historical buffering score is based on: (i) a mean duration score based on a mean time duration, and (ii) a standard deviation score based on a standard deviation, of said some of said segments classified as buffering segments in said one or more time windows preceding said current time window.

16. The computer-implemented method of claim 15, wherein said current streaming service score is calculated as a weighted combination of (i) said current window buffering score, and (ii) said historical buffering score.

17. A computer program product comprising a non-transitory computer-readable storage medium having program instructions embodied therewith, the program instructions executable by at least one hardware processor to:
receive, at a communications network interface, telemetry data representing a streaming service instance provided to an end-device by a remote streaming server over the Internet; and
recursively, with respect to each current time window:
(i) divide, based on said telemetry data, said time window into segments, wherein each of said segments is classified based on its buffering status as a buffering segment or a non-buffering segment,
(ii) calculate a current streaming service score, based on said buffering status of at least one of said segments within said current time window, and
(iii) update a quality of service (QoS) rating for said streaming media service instance, based, at least in part, on said current streaming service score.

18. The computer program product of claim 17, wherein, when said last one of said segments ending within said current time window is classified as a buffering segment, said current streaming service score is equal to a last segment score, calculated as a weighted combination of: (i) a data rate score based on a standard deviation of said data rate metrics in said last one of said segments; and (ii) a packet loss score based on said packet loss rate metrics in said last one of said segments.

19. The computer program product of claim 13, wherein said current streaming service score is further based on a longest segment score, calculated based on said data rate metrics and a time duration value of the longest one of said segments classified as a buffering segment and ending within said current time window, and wherein said current streaming service score is equal to a current window buffering score calculated as a weighted combination of (i) said last segment score, and (ii) said longest segment score.

20. The computer program product of claim 19, wherein said current streaming service score is further based on an historical buffering score, calculated based on time duration values of at least some of said segments classified as buffering segments in one or more time windows preceding said current time window, and wherein said current streaming service score is calculated as a weighted combination of (i) said current window buffering score, and (ii) said historical buffering score.
